(19) United States
(12) Patent Application Publication
(10) Pub. No.: US 2023/0309059 A1
(43) Pub. Date: Sep. 28, 2023

(54) USER ALERT FOR CHANGE IN NETWORK COVERAGE

(71) Applicant: Apple Inc., Cupertino, CA (US)

(72) Inventors: Anikethan Ramakrishna VIJAYA KUMAR, Mysuru (IN); Arjun Ramesh SHETTY, Bangalore (IN); Shrinidhi RAMACHANDRA, Bangalore (IN)

(21) Appl. No.: 18/190,196

(22) Filed: Mar. 27, 2023

Related U.S. Application Data
(60) Provisional application No. 63/269,990, filed on Mar. 28, 2022.

(51) Int. Cl. H04W 68/00

(52) U.S. Cl. CPC H04W 68/00

(57) ABSTRACT

A user equipment (UE) is configured to identify a user event while the UE is in a first type of network coverage, wherein the UE enables a feature configured to alert a user to a change in network coverage in response to the user event, identify the change in network coverage from the first type of network coverage to a second type of network coverage and generate an alert in response to identifying the change in network coverage, wherein the alert is configured to notify a user of the UE to the change in network coverage.

### PRIORITY/INCORPORATION BY REFERENCE

This application claims priority to U.S. Provisional Application 63/269,990 filed on Mar. 28, 2022 and entitled “User Alert for Change in Network Coverage,” the entirety of which is incorporated by reference herein.

### BACKGROUND

A user equipment (UE) may connect to multiple different types of networks. Under conventional circumstances, the user may only become aware of a change in network coverage if the user turns on the display of the UE to check for a visual indication of the type of available network coverage (e.g., no service, 5G, LTE, 3G, etc.). Not only is this inconvenient for the user when experiencing prolonged or frequent instances of no service or limited service, frequently turning on the display to check for the desired network coverage may cause the UE to experience a power drain.

### SUMMARY

Some exemplary embodiments are related to a method performed by a user equipment (UE). The method includes identifying a user event while the UE is in a first type of network coverage, wherein the UE enables a feature configured to alert a user to a change in network coverage in response to the user event, identifying the change in network coverage from the first type of network coverage to a second type of network coverage and generating an alert in response to identifying the change in network coverage, wherein the alert is configured to notify a user of the UE to the change in network coverage.

Other exemplary embodiments are related to a processor configured to identify a user event while the UE is in a first type of network coverage, wherein the UE enables a feature configured to alert a user to a change in network coverage in response to the user event, identify the change in network coverage from the first type of network coverage to a second type of network coverage and generate an alert in response to identifying the change in network coverage, wherein the alert is configured to notify a user of the UE to the change in network coverage.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows a method for alerting a user to a change in network coverage according to various exemplary embodiments.

FIG. 4 shows a method for generating a notification for recovery of service according to various exemplary embodiments.

FIG. 5 shows an exemplary deployment scenario according to various exemplary embodiments.

FIG. 6 shows a method for generating a notification for recovery of emergency services according to various exemplary embodiments.

FIG. 7 shows an exemplary deployment scenario according to various exemplary embodiments.

FIG. 8 shows a method for generating a notification for availability of preferred Radio Access Technology (RAT) according to various exemplary embodiments.

FIG. 9 shows an exemplary deployment scenario according to various exemplary embodiments.

### DETAILED DESCRIPTION

The exemplary embodiments may be further understood with reference to the following description and the related appended drawings, wherein like elements are provided with the same reference numerals. The exemplary embodiments introduce techniques for improving the user experience associated with scenarios in which a user equipment (UE) moves between different types of network coverage.

The exemplary embodiments are described with regard to a user equipment (UE). However, reference to a UE is provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with regard to multiple types of radio access technologies (RATS). For example, reference may be made to fifth generation (5G) networks such as New Radio (NR), fourth generation (4G) networks such as Long-Term Evolution (LTE) and legacy networks such as, but not limited to, third generation (3G) Wideband Code Division Multiple Access (WCDMA) networks and the second generation (2G) Global System for Mobile Communications (GSM) networks. Throughout this description, any reference to a particular RAT is merely provided for illustrative purposes, those skilled in the art will understand that the exemplary embodiments may apply to any appropriate RAT.

The exemplary embodiments are further described with regard to scenarios in which the UE moves between different types of network coverage. For example, at a first time, the UE may identify one or more different types of networks are available. However, the available networks may be unable to provide access to services that the user intends to utilize. At a second time, the UE may move to a different location and then identify that a new type of network coverage is now available that may be able to provide access to services that the user intends to utilize.

Under conventional circumstances, when the UE moves to a new type of network coverage, the user may only become aware of the change in coverage if the user turns on the display of the UE to check for a visual indication of a type of available network coverage (e.g., no service, 5G, LTE, 3G, etc.). Not only is this inconvenient for the user, frequently turning on the display to check for the desired network coverage may cause the UE to experience a power drain.

The exemplary embodiments introduce techniques for alerting the user to a change in network coverage. These exemplary techniques may enhance the user experience associated with the UE having no service or limited service by alerting the user and/or autonomously performing an operation when a new type of network coverage becomes available. In some examples, the change in network coverage may be described as a transition from no coverage to a particular RAT (e.g., 5G NR, LTE, legacy, etc.). In other examples, the change in coverage may be described as a transition from no coverage to a type of public land mobile network (PLMN) (e.g., home PLMN (HPLMN), visited PLMN (VPLMN), etc.). In further examples, the change in coverage may be described as a transition from a first RAT to a second different RAT. While the exemplary embodiments may provide benefits to these types of scenarios, the exemplary embodiments are not limited to any particular type of change in network coverage and/or available network services.

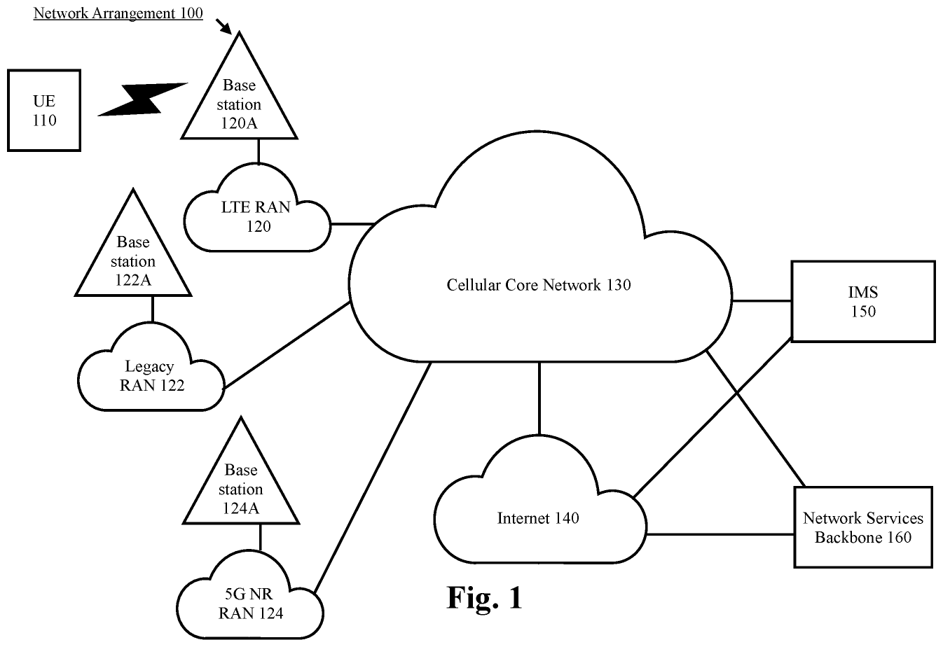

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network arrangement 100, the networks with which the UE 110 may wirelessly communicate are an LTE radio access network (RAN) 120, a legacy RAN 122 and a 5G New Radio (NR) RAN 124. However, the UE 110 may also communicate with other types of networks and the UE 110 may also communicate with networks over a wired connection. With regard to the exemplary embodiments, the UE 110 may establish a connection with the LTE-RAN 120, legacy RAN 122 and/or the 5G NR-RAN 124. Therefore, the UE 110 may have an LTE chipset to communicate with the LTE-RAN 120, a legacy chipset to communicate with the legacy RAN 122 and a 5G NR chipset to communication with the 5G NR-RAN 124.

In the network arrangement 100, reference to a single legacy RAN 122 is merely provided for illustrative purposes, the term legacy RAN (or network) is applicable to various types of networks. For example, the legacy RAN 122 may represent a 3G WCDMA network or a 2G GSM network. Thus, in an actual network arrangement there may be multiple legacy RANs deployed within the vicinity of the UE 110.

The LTE-RAN 120, the legacy RAN 122 and the 5G NR RAN 124 may be portions of cellular networks that may be deployed by cellular providers (e.g., Verizon, AT&T, T-Mobile, etc.). These networks 120, 122 and 124 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

The UE 110 may connect to the LTE-RAN 120 via a base station 120A. Those skilled in the art will understand that any association procedure may be performed for the UE 110 to connect to the LTE-RAN 120. For example, as discussed above, the LTE-RAN 120 may be associated with a particular cellular provider where the UE 110 and/or the user thereof has a contract and credential information (e.g., stored on a SIM card). Upon detecting the presence of the LTE-RAN 120, the UE 110 may transmit the corresponding credential information to associate with the LTE-RAN 120. More specifically, the UE 110 may associate with a specific base station (e.g., base station 120A of the LTE-RAN 120). Similarly, the UE 110 may also connect to the legacy RAN 122 via the base station 122A or the 5G NR RAN 124 via the base station 124A.

The network arrangement 100 also includes a cellular core network 130, the Internet 140, an IP Multimedia Subsystem (IMS) 150, and a network services backbone 160. The cellular core network 130 may be considered to be an interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

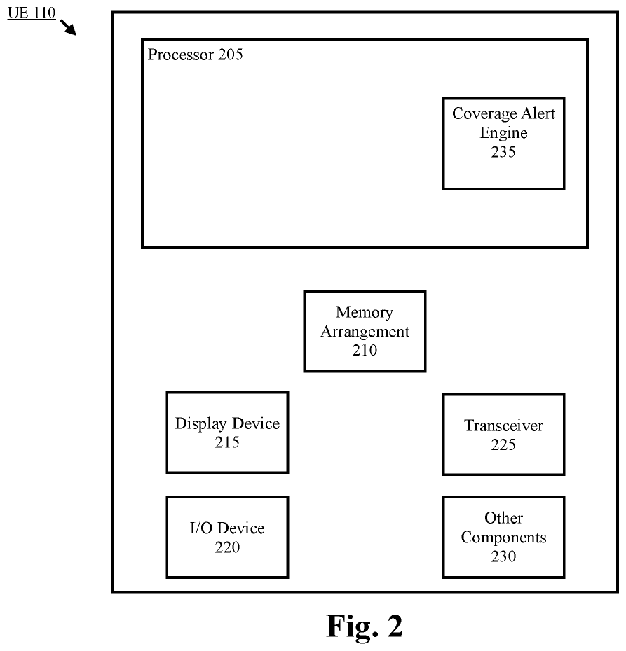

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines of the UE 110. For example, the engines may include a coverage alert engine 235. The coverage alert engine 235 may perform various operations such as, but not limited to, detecting different types of network coverage, generating an alert to the user indicating a change in network coverage and autonomously triggering an operation (e.g., without user intervention) based on identifying a change in the type of network coverage.

The above referenced engine 235 being an application (e.g., a program) executed by the processor 205 is only exemplary. The functionality associated with the engine may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the LTE-RAN 120, the legacy RAN 122, the 5G NR RAN 124, etc. Accordingly, the transceiver 225 may operate on a variety of different frequencies or channels (e.g., set of consecutive frequencies).

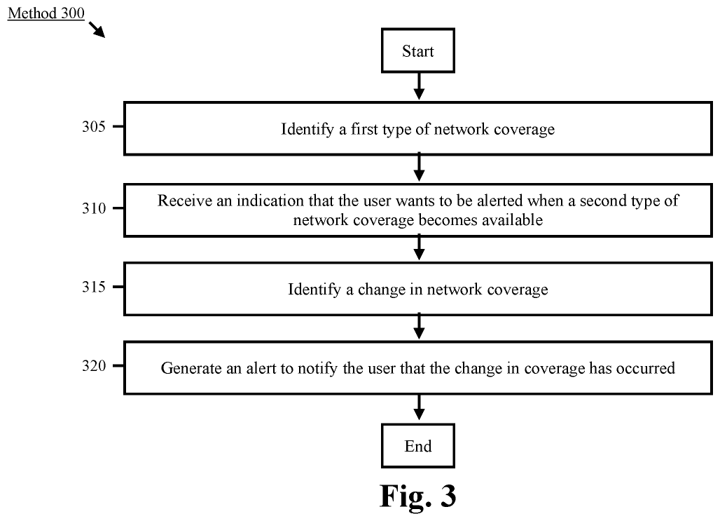

FIG. 3 shows a method 300 for alerting a user to a change in network coverage according to various exemplary embodiments. The method 300 will be described with regard to the network arrangement 100 of FIG. 1 and the UE 110 of FIG. 2.

In 305, the UE 110 identifies a first type of network coverage. For example, the UE 110 may tune its transceiver 225 and scan various frequencies for signals broadcast by a base station. The UE 110 may receive a signal from zero or more base stations indicating that a type of network coverage is available (e.g., synchronization signal block (SSB), primary synchronization signal (PSS), secondary synchronization signal (SSS), physical broadcast channel (PBCH), system information block (SIB), layer 1 (L1) signals, layer 2 (L2) signals, layer 3 (L3) signals, etc.). In addition, the UE 110 may collect measurement data associated with the base stations (e.g., reference signal received power (RSRP), reference signal received quality (RSRQ), etc.). The UE 110 may utilize information from these types of signals and/or measurement data to determine whether any base stations are available to the UE 110. However, the manner in which the UE 110 identifies that a particular network is available and collects measurement data is beyond the scope of the exemplary embodiments. The exemplary embodiments may identify that a particular network (or no network) is available in any appropriate manner.

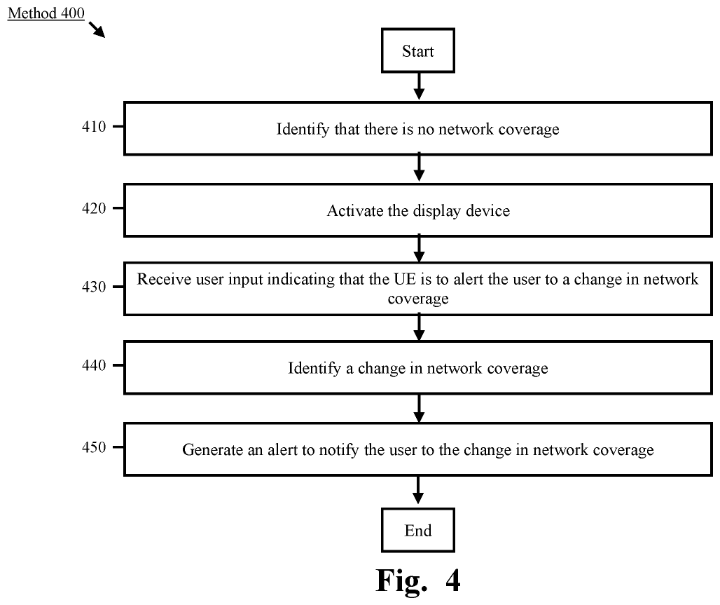

As will be described in more detail below with regard to FIGS. 4-9, in some examples, the first type of network coverage may be no coverage. In other examples, the first type of network coverage may be a PLMN and/or a RAT that does not have access to network services that the user intends to utilize (e.g., voice call, data session, a particular application, etc.).

In 310, the UE 110 receives an indication that the user wants to be alerted when a second type of network coverage becomes available. The user may want to be alerted to any of a variety of different types of network coverage. In other examples, the user may want to be alerted when a particular PLMN, RAT, network slice and/or Protocol Data Unit (PDU) session that is expected to provide access to network services that the user intends to utilize is available (e.g., voice calls, emergency calls, data sessions, a particular application, etc.). The UE 110 may be configured to generate an alert in response to any change in network coverage or only certain types of changes. The user may specify the type of changes the user wants to be alerted to or the types of changes may be preconfigured at the UE 110.

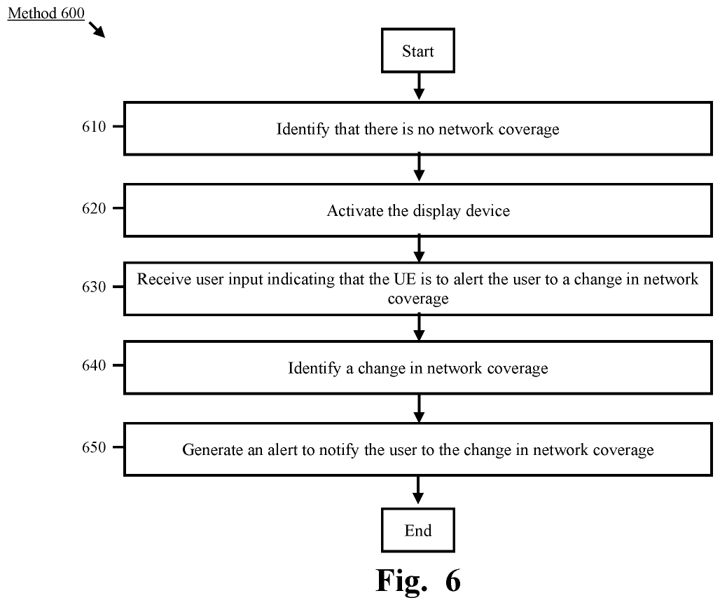

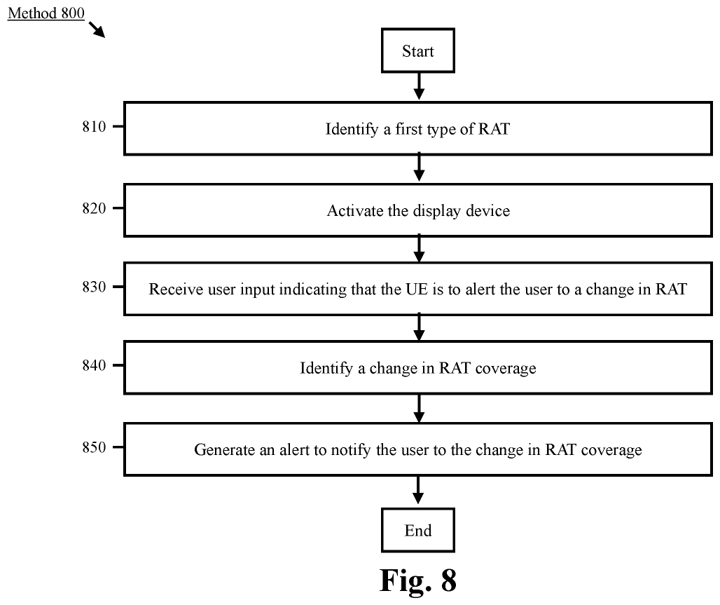

The exemplary embodiments are described with regard to a “user event.” As will be described in more detail below, the term “user event” refers to an action, operation or condition that is configured to trigger the alert functionality described herein. Thus, the user may indicate to the UE 110 that the user wants to be alerted when a second type of network coverage becomes available (e.g., 310 of the method 300). Subsequently, a user event may occur that triggers the UE 110 to generate the alert when the change in coverage occurs. In some embodiments, the user may specify the type of actions, operations and/or conditions that are to trigger the alert functionality when the user provides an indication to the UE 110 of their desire to be alerted to a change in network coverage. In other embodiments, the indication provided by the user of their desire to be alerted to a change in network coverage and the user event may be the same action, operation or condition. Additional details regarding the scope of the term “user event” are provided below. Specific examples of a user event are provided below with regard to the method 400 of FIG. 4, the method 600 of FIG. 6 and the method 800 of FIG. 8.

According to some exemplary embodiments, the user interface (UI) of the UE 110 may be configured to display a notification requesting the user to select whether the user would like to enable triggering of the alert when the network coverage changes. The user input in response to this request may be considered a user event. This is one example of an action that may be considered both a user event and an indication provided by the user indicating their desire to be alerted to a change in network coverage. In another example, instead of the UE 110 displaying a notification, the user may manually configure a setting to alert the user to a change in network coverage and/or specify one or more different types of user events that may trigger the alert functionality.

The UE 110 may display the notification to the user in response to any of a variety of different predetermined conditions. For instance, consider a scenario in which the UE 110 has no service and the display device 215 of the UE 110 is deactivated or asleep. The user then activates the display device 215 while the UE 110 has no service. In response to the user activating the screen, the UE 110 may generate the notification requesting the user to indicate if the user would like to enable triggering of the alert when a second type of network coverage becomes available.

To provide another example of the type of predetermined conditions that may trigger the notification referenced above, consider a scenario in which the UE 110 has no service, limited service or is connected to a particular RAT. The user intends to utilize an application or feature of an application that is not supported by the current RAT or service state. For instance, the user may launch an application to perform a voice call. However, the UE 110 may be unable to establish and/or maintain the session for the voice call due to the current RAT, no service or limited service state. In response to the inability of the UE 110 to establish or maintain the session for the voice call, the UE 110 may automatically display the notification and request the user to select whether the user would like to enable triggering of the alert when the second type of network coverage becomes available. As will be described in more detail below, instead of triggering the notification referenced above, the UE 110 may consider the failure to establish and/or maintain a user requested session a user event and automatically generate an alert when the second type of network coverage becomes available without any explicit indication by the user.

In another exemplary predetermined condition, the UE 110 may be triggered to display the notification to user after the UE 110 detects no service, limited service, a type of RAT or a type of PLMN for a predetermined duration of time. In another exemplary predetermined condition, the UE 110 may be triggered to display the notification to user the UE 110 based on the UE 110 detecting no service, limited service, a type of RAT or a type of PLMN (X) number of times within a time window (Y). Further exemplary predetermined conditions for triggering the notification may include, but are not limited to, the user activating a lock screen a predetermined number of times while deployed within the first type of network coverage, the user unlocking the UE 110 a predetermined number of time while deployed within the first type of network coverage, the user launching or opening an application of the UE 110 a predetermined number of times while deployed within the first type of network coverage, a combination of any of these actions, or any other appropriate indication that the user wants to utilize the UE 110 but the UE 110 is likely unable to perform the desired function due to the first type of network coverage.

Instead of or in addition to exemplary notification-based mechanisms described above, the UE 110 may be configured to automatically alert the user when a second type of network coverage becomes available based on the occurrence of a user event. The user may manually configure which types of actions, operations and/or conditions are to be considered a user event and/or the UE 110 may be configured with one or more user events that trigger the UE 110 to automatically generate an alert when the second type of network coverage becomes available without any explicit indication by the user.

As indicated above, in some examples, the user event may be the failure of the UE 110 to maintain and/or establish a session. Thus, the user event may be the user attempting to utilize an application (e.g., voice call, data session, etc.) that is not supported by the current type of network coverage or the application has experienced a certain number of connectivity issues within a certain time window. In a further example, the user event may be the user activating the display device 215 and/or unlocking the UE 110 a predetermined number of times within a predetermined time window. For example, if the user activates the display device 215 (N) times within a time window (W) while the UE 110 has no service or limited service, the UE 110 may be triggered to generate an alert to the user when a change in network coverage occurs. In another example, a user event may be the UE 110 detecting no service, limited service, a type of RAT or a type of PLMN for a predetermined duration of time and/or the UE 110 detecting no service, limited service, a type of RAT or a type of PLMN (X) number of times within a time window (Y).

The above examples may allow the UE 110 to alert the user to instances of patchy coverage where the UE 110 may frequently experience no service, limited service, a type of RAT or a type of PLMN or experience a particular type of network coverage for a prolonged period of time. However, the exemplary embodiments are not limited to the examples provided above. The UE 110 may be configured to provide the network coverage alert based on user input, a preconfigured setting, a predetermined condition, any combination thereof or any other appropriate type of trigger condition.

The exemplary embodiments are not limited to the examples provided above. The UE 110 may be configured to provide the network coverage alert based on user input, a preconfigured setting, a predetermined condition, any combination thereof or any other appropriate type of trigger condition.

In 315, the UE 110 identifies a change in network coverage. For example, while the UE 110 is deployed within the first type of network coverage, the UE 110 may scan various frequencies searching for signals broadcasted by a base station that the UE 110 is not currently connected. The UE 110 may receive a signal from one or more base stations indicating that a type of network coverage is available. In addition, the UE 110 may also collect measurement data associated with the base stations. The UE 110 may then utilize information from these types of signals and/or measurement data to determine whether any different networks are available. However, as mentioned above, the manner in which the UE 110 identifies that coverage is available and collects measurement data is beyond the scope of the exemplary embodiments. The exemplary embodiments may identify that a type of network coverage is available in any appropriate manner.

In some embodiments, the change in network coverage may be the UE 110 transitioning from no coverage to a coverage area of a VPLMN where the UE 110 is only permitted to make emergency calls. In other embodiments, the change in coverage may be the UE 110 transitioning from no coverage to a network that is expected to provide the UE 110 with normal service. In further embodiments, the change in coverage may be the UE 110 transitioning from one RAT to a coverage area of a different RAT (e.g., legacy to LTE or 5G, LTE to 5G, etc.). In still further embodiments, a change in network conditions may also mean activation of a previously rejected PDU session, Packet Data Network (PDN) or network slice. However, these examples are merely provided for illustrative purposes, the exemplary embodiments may apply to any type of change in network coverage experienced by the UE 110.

In 320, the UE 110 generates an alert to notify the user that the change in network coverage has occurred. The UE 110 may generate the alert in a variety of different ways. For example, the UE 110 may generate the alert in the form of audio output (e.g., ring, beep, click, etc.). In another example, the UE 110 may generate an alert in the form of a visual alert (e.g., a pop-up message, activating the display device 215, a notification, etc.). For instance, the UE 110 may generate a notification on the display device 215 to alert the user that the change in coverage has occurred. In a further example, the UE 110 may generate an alert in the form of a vibration. Thus, the UE 110 may vibrate as a way of alerting the user when the change in coverage has occurred. The exemplary embodiments are not limited to the examples provided above. The UE 110 may be configured to provide an alert to the user using any combination of the one or more examples provided above or in any other appropriate manner.

In some embodiments, instead of or in addition to alerting the user about the change in coverage, the UE 110 may be configured to autonomously perform a particular operation. The type of operation may be specified by user input in response to a notification displayed on the UI of the UE 110 or by a preconfigured setting. In addition, the type of operation performed by the UE 110 in response to the change in coverage may be based on identifying the second type of network coverage or one or more attempts to utilize an application or feature of an application when the UE 110 was deployed within the first type of network coverage. For example, the UE 110 may be configured to autonomously initiate a voice call or send a message when the UE 110 identifies that the second type of network coverage is available. In another example, the UE 110 may be configured to autonomously launch an application when the UE 110 identifies that the second type of network coverage is available. The type of operation triggered by the UE 110 may be based on user input, a preconfigured setting, attempting to utilize an application when the UE 110 was deployed within the first type network coverage or any other appropriate basis.

FIG. 4 shows a method 400 for generating a notification for recovery of service according to various exemplary embodiments. The method 400 provides an example of utilizing the exemplary techniques within the context of a specific type of deployment scenario. As will be described in more detail below, the method 400 is described with regard to a scenario in which the UE 110 travels through areas with no network coverage and areas where the network coverage should allow the UE 110 to access services that are normally expected to be available via the network connection (e.g., voice calls, data sessions, etc.).

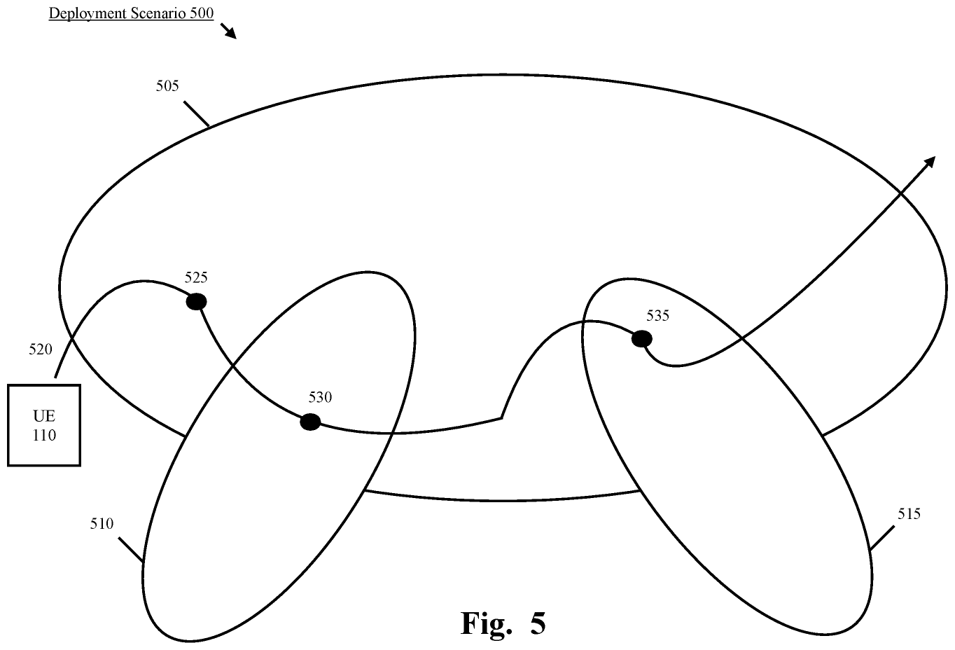

FIG. 5 shows an exemplary deployment scenario 500 according to various exemplary embodiments. The deployment scenario 500 provides context for the description of the method 400 provided below. In the deployment scenario 500, a first area 505 represents a geographical area where there is no network coverage. A second area 510 represents a geographical area where a type of network coverage is available that allows the UE 110 access services normally expected to be available via the network connection (e.g., normal service, legacy RAN 122, LTE RAN 120, 5G NR RAN 124, etc.). The deployment scenario 500 also includes a third area 515 that represents a geographical location where a type of network coverage is available that allows the UE 110 access services normally expected to be available via the network connection. This type of network coverage may be the same or different as the type of network coverage corresponding to the second area 510.

The deployment scenario 500 further includes a path 520 that represents a path the UE 110 travels. The path 520 includes a point 525 that represents a point at which the user intends to make a voice call or initiate a data session. However, since the UE 110 has no service when deployed within the first area 505, the UE 110 is unable to perform the voice call or establish the data session. Under conventional circumstances, the user may enter and exit the different types of network coverages 505-515 without being aware of when a change in network coverage occurs. Thus, the user may only be aware of the presence of a network that allows the UE 110 to access network services the user intends to utilize if the user were to check the display device 215 of the UE 110 while the UE 110 is deployed within area 510 or 515. The method 400 will be described below with regard to the deployment scenario 500. However, the exemplary embodiments are not limited to this type of deployment scenario and may apply to any scenario in which the UE 110 moves between different types of network coverages.

Returning to the method 400, in 410, the UE 110 identifies that there is no network coverage available. For example, the UE 110 may tune its transceiver 225 to scan various frequencies and search for a base station. However, during the search the UE 110 may not receive any signals or the UE 110 may receive a signal from a base station but the measurement data associated with the signal (or base station) does not satisfy a threshold value.

To provide an example, the deployment scenario 500 may include a path 520 that represents a path a user is to take on a hike. Once the user enters the first area 505, the UE 110 identifies a first type of network coverage (e.g., no service, limited service, etc.). As described above, in the deployment scenario 500, the first area 505 is an area with no network coverage.

In 420, a user event occurs. As indicated above, the user event may be an action, operation and/or condition that enables triggering of the alert when the network coverage changes. For example, the user may attempt to utilize an application while deployed within the first area 505 at point 525. The user may attempt to make a voice call, use a navigation application, post a photo to social media or use any other type of application. However, since there is no network coverage in area 505, the user may be unable to utilize the application as they intended. Failure to establish and/or maintain a session for the desired application may be considered a user event which triggers the UE 110 to generate the alert when the change in network coverage occurs.

In another example, the user event may be user input provided in response to a notification requesting the user to select whether the user would like to be alerted to a change in network coverage. The notification may be triggered based on any appropriate type of predetermined condition. For instance, the user may attempt to utilize an application to make a voice call when deployed within the first area 505 at point 525. Since there is no network coverage in the first area 505, the call is unsuccessful. This may trigger the UE 110 to generate a notification requesting the user to select whether the user would you like an alert when there is a change in network coverage.

As indicated above, the exemplary embodiments are not limited to these types of user events. In other examples, the user event may be the user activating the display and/or unlocking a lock screen a predetermined number of times while deployed within the first type of network coverage. Advantageously, the alert mechanism prevents the user from frequently turning on the display to check for the desired coverage and consequently prevents the UE 110 from experiencing a power drain.

In 430, the UE 110 identifies a change in network coverage. For example, the user may move to point 530 within the second area 510 or point 535 within the third area 515. In 440, the UE 110 generates an alert to notify the user to the change in network coverage. For example, the user may be alerted to the change in network coverage when the user enters the second area 510 or the third area 515. The alert may be provided in any of a variety of different ways. In an example, the UE 110 may notify the user via an audio, visual or vibrating alert. In another example, UE 110 may alert the user and initiate a call or data session that previously failed when the user was deployed within the first area 505.

In some embodiments, the UE 110 may notify the user when there has been no change in network coverage for a certain amount of time. This may be implemented to prevent the user from frequently checking the display device 215 for an indication of change in service after the user indicates that the user would like to be alerted to a change in network coverage. For example, the UE 110 may be configured to generate an alert when there is no change in network coverage after the user is deployed within the first area 505 for (X) amount of time. This alert may be different than the alert indicating the change in network coverage. Those of ordinary skill in the art will understand that these methods of notifying the user are exemplary and other methods can be implemented.

FIG. 6 shows a method 600 for generating a notification for recovery of emergency service according to various exemplary embodiments. The method 600 provides an example of utilizing the exemplary techniques within the context of a specific type of deployment scenario. As will be described in more detail below, the method 600 is described with regard to a scenario in which the UE 110 travels through areas with no network coverage, areas with VPLMN coverage that only allows the UE 110 to access emergency services and areas with HPLMN coverage that allows the UE 110 to access services that are normally expected to be available via their HPLMN (e.g., voice calls, data sessions, etc.).

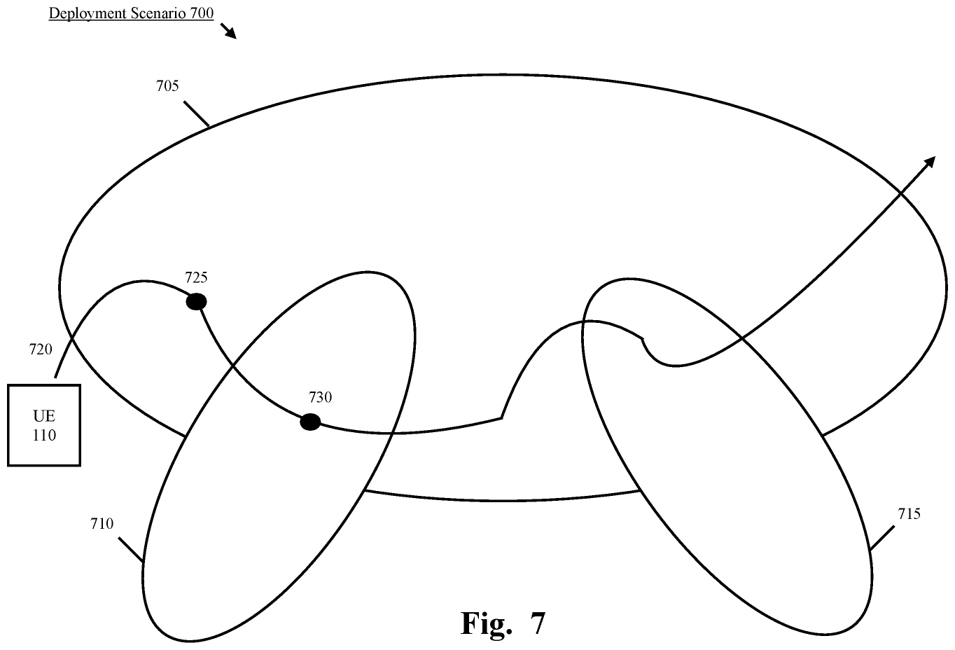

FIG. 7 shows an exemplary deployment scenario 700 according to various exemplary embodiments. The deployment scenario 700 provides context for the description of the method 600 provided below. In the deployment scenario 700, a first area 705 represents a geographical area where there is no network coverage. A second area 710 represents a geographical area where there is a VPLMN that only allows the UE 110 to access emergency services. The deployment scenario 700 also includes a third area 715 that represents a geographical area where there is an HPLMN that allows the UE 110 access services that are normally expected to be available via their HPLMN (e.g., voice calls, data sessions, etc.). The deployment scenario 700 further includes a path 720 that represents a path the user travels. The path 720 includes a point 725 that represents a point at which a user intends to make an emergency call. However, since the UE 110 has no service when deployed within the first area 705, the UE 110 is unable to perform the emergency call. The method 600 will be described below with regard to the deployment scenario 700. However, the exemplary embodiments are not limited to this type of deployment scenario and may apply to any scenario in which the UE 110 moves between different types of network coverage.

Returning to method 600, in 610, the UE 110 identifies that there is no network coverage. To provide an example, the deployment scenario 700 may include a path 720 that represents a path a user is to take on a hike. Once the user enters the first area 705, the UE 110 identifies the first type of network coverage (e.g., no service, limited service, etc.). As described above, in the deployment scenario 700, the first area 705 is an area with no network coverage.

In 620, a user event occurs. As indicated above, the user event may be an action, operation and/or condition that enables triggering of the alert when the network coverage changes. For example, the user may attempt to make an emergency call. However, since there is no network coverage in area 705, the UE 110 may be unable to make the emergency call. Thus, failure to establish and/or maintain a session for an emergency call may be considered a user event which triggers the UE 110 to generate the alert when the change in network coverage occurs.

In another example, the user event may be user input provided in response to a notification requesting the user to select whether the user would like to be alerted to a change in network coverage. The notification may be triggered based on any appropriate type of predetermined condition such as failure to establish and/or maintain a session for the emergency call.

In some scenarios, the user may activate a display and notice an icon indicating that the UE 110 currently has not service. This may prevent the user from attempting to make the emergency call (or utilize another service that requires a network connect). Thus, in some embodiments, the user event may be the user activating the display device 215 of the UE 110 and/or unlocking a lock screen a predetermined number of times while deployed within the first type of network coverage. In other embodiments, the user activating the display device 215 of the UE 110 and/or unlocking a lock screen a predetermined number of times while deployed within the first type of network coverage may trigger the UE 110 to display a notification requesting the user to select whether the user would like to be alerted when a change in network coverage occurs. If the user knows that the UE 110 will provide an audio or vibration alert when a change in network coverage occurs, it may prevent the user from frequently turning on the display to check for the desired coverage and consequently prevents the UE 110 from experiencing a power drain.

In 630, the UE 110 identifies a change in network coverage. For example, the user may move to point 730 within the second area 710. As mentioned above, area 710 corresponds to a VPLMN where the UE 110 is only permitted to access emergency services.

In 640, the UE 110 generates an alert to notify the user to the change in network coverage. To provide one example, the user may be alerted to the change in network coverage when the user enters the second area 710. The alert may be provided in any of a variety of different ways. For instance, the UE 110 may notify the user via an audio, visual and/or vibrating alert. In some embodiments, the UE 110 may alert the user and initiate an emergency call that previously failed when the user was deployed within first area 705 in response to the change in network coverage.

FIG. 8 shows a method 800 for generating a notification for availability of a preferred RAT according to various exemplary embodiments. The method 800 provides an example of utilizing the exemplary techniques within the context of a specific type of deployment scenario. As will be described in more detail below, the method 800 is described with regard to a scenario in which the UE 110 travels through areas with legacy RAT coverage (e.g., 3G network, 2G network, etc.) LTE RAT coverage and 5G NR RAT coverage. Some applications or features of an application may only be supported by a particular type of RAT. Thus, the user may intend to utilize an application or a feature of an application that is not supported by the current RAT.

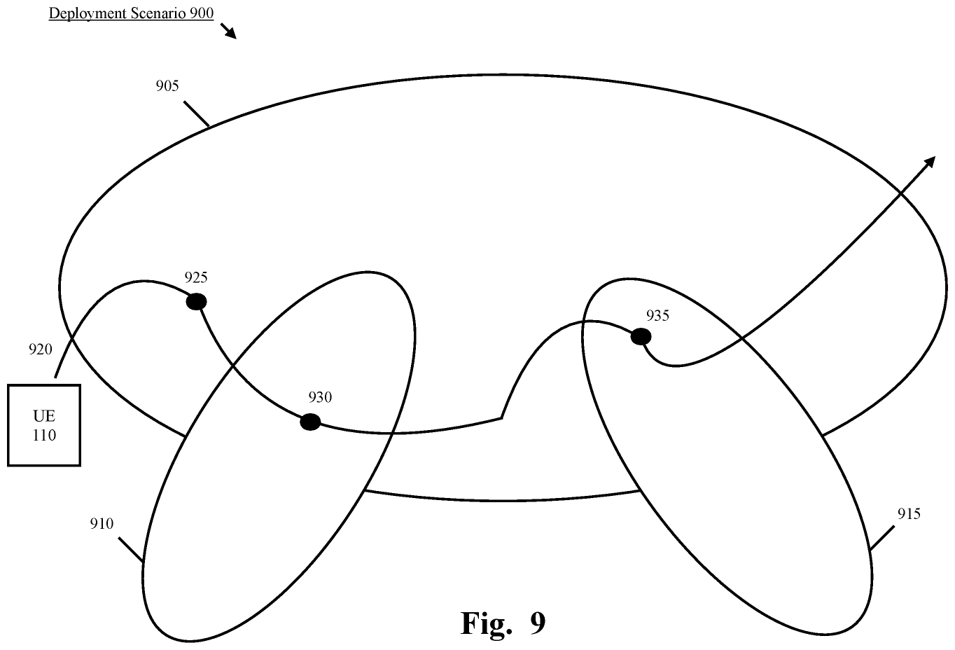

FIG. 9 shows an exemplary deployment scenario 900 according to various exemplary embodiments. The deployment scenario 900 provides context for the description of the method 800 provided below. In the deployment scenario 900, a first area 905 represents a geographical area where there is legacy RAT coverage. However, the legacy RAT coverage does not support access to an application or feature of an application that the user intends to utilize. A second area 910 represents a geographical area where there is LTE RAT coverage that allows the UE 110 to utilize applications that are supported by the LTE RAT and not supported by legacy RAT. The deployment scenario 900 also includes a third area 915 that represents a geographical area where there is 5G NR RAT coverage that allows the UE 110 access applications that are supported by 5G RAT and not supported by legacy RAT or the 4G RAT.

The deployment scenario 900 further includes a path 920 that represents a path the user travels. The path 920 includes a point 925 that represents a point at which a user intends to use an application that is not supported by the legacy RAT. However, since UE 110 is deployed in the first area 905, the UE 110 is unable to utilize the application as they intended. The method 800 will be described below with regard to the deployment scenario 900. However, the exemplary embodiments are not limited to this type of deployment scenario and may apply to any scenario in which the UE 110 moves between different types of RATS. For example, the exemplary embodiments may apply to a scenario in which the user moves between LTE RAT coverage and 5G NR coverage.

Returning to method 800, in 810, the UE 110 identifies a first type of RAT. To provide an example, the deployment scenario 900 may include a path 920 that represents a path the user is to take on a hike. Once the user enters the first area 905, the UE 110 identifies the legacy RAT. As described above, in the deployment scenario 900, the first area 905 is an area with legacy RAT coverage.

In 820, a user event occurs. As indicated above, the user event may be an action, operation and/or condition that enables triggering of the alert when the network coverage changes. For example, the user may attempt to utilize an application while being deployed within the first area 905 at point 925. However, the application may only be supported by RATS higher than the first type of RAT (e.g., LTE RAT, 5G NR RAT, etc.). Since the available RAT in area 905 is a legacy RAT, the UE 110 may be unable to establish the type of session that would allow the user to utilize the preferred application as they intended. Thus, failure to establish and/or maintain a session or access a particular network slice for an application may be considered a user event which triggers the UE 110 to generate the alert when the change in network coverage occurs.

In another example, the user event may be user input provided in response to a notification requesting the user to select whether the user would like to be alerted to a change in network coverage. The notification may be triggered based on any appropriate type of predetermined condition such as failure to establish and/or maintain a session for a particular application or feature of an application. For instance, the user may attempt to utilize a preferred application that is supported by a RAT higher than the first type of RAT (e.g., 4G RAT, 5G RAT, etc.) within the first area 905. Since the RAT in the first area 905 is a legacy RAT, the UE 110 is unable to establish a session and/or access a network slice that is needed to utilize the desired application. This may trigger the UE 110 to generate a notification requesting the user to select whether the user would like to an alert when a change in RAT occurs.

In 830, the UE 110 identifies a change in RAT coverage. For example, the user may move to point 930 within the second area 910 where there is LTE coverage or point 935 within the third area 915 where there is 5G NR coverage.

In 840, the UE 110 generates an alert for the user based on identifying the change in coverage. The UE 110 may consider a type of RAT and a type of application the user intends to utilize prior to generating the alert. For instance, if the UE 110 received an indication that the user intends to utilize an application that prefers a 5G NR RAT, the UE 110 may not alert the user to the change in RAT if the RAT is LTE.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described methods may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A method performed by a user equipment (UE), comprising:
identifying a user event while the UE is in a first type of network coverage, wherein the UE enables a feature configured to alert a user to a change in network coverage in response to the user event;
identifying the change in network coverage from the first type of network coverage to a second type of network coverage; and
generating an alert in response to identifying the change in network coverage, wherein the alert is configured to notify a user of the UE to the change in network coverage.

2. The method of claim 1, wherein the user event comprises a failure to establish or maintain a session for a voice call.

3. The method of claim 2, wherein the first type of network coverage is no network coverage and the second type of network coverage comprises a network offering voice call services.

4. The method of claim 1, wherein the user event comprises a failure to establish or maintain a session for an emergency call.

5. The method of claim 4, wherein the first type of network coverage is no network coverage and the second type of network coverage permits UE access to emergency services.

6. The method of claim 1, wherein the user event comprises a failure to establish or maintain a session for an application.

7. The method of claim 6, wherein the first type of network coverage is a legacy radio access technology (RAT) and the second type of network coverage is a long term evolution (LTE) RAT or a fifth generation (5G) new radio (NR) RAT.

8. The method of claim 1, wherein the alert comprises one of audio output and a vibration.

9. The method of claim 1, further comprising:
performing an operation in response to identifying the change in network coverage without user intervention, wherein the operation comprises one of initiating a voice call, a data session or an emergency call.

10. The method of claim 9, wherein the operation was previously attempted prior to the change in network coverage.

11. The method of claim 1, wherein the user event comprises activating a display of the UE or unlocking the UE a predetermined number of times while deployed within the first type of network coverage.

12. The method of claim 1, wherein the user event comprises receiving user input in response to a request for the user to enable the feature configured to alert the user to the change in network coverage, and
wherein the request is displayed at the UE in response to a predetermined condition.

13. The method of claim 12, wherein the predetermined condition is based on one or more of a type of network coverage being unavailable, a duration of time the UE is deployed within the first type of network coverage, a number of times a display device of the UE is activated, a number of times the UE is unlocked, a failure to establish a communication session while deployed in the first type of network or a number of times the UE identifies the first type of network coverage within a time window.

14. A processor of a user equipment (UE) configured to:
identify a user event while the UE is in a first type of network coverage, wherein the UE enables a feature configured to alert a user to a change in network coverage in response to the user event;
identify the change in network coverage from the first type of network coverage to a second type of network coverage; and
generate an alert in response to identifying the change in network coverage, wherein the alert is configured to notify a user of the UE to the change in network coverage.

15. The processor of claim 14, wherein the user event comprises one of a failure to establish or maintain a session for a voice call, a failure to establish or maintain a session for an emergency call, or a failure to establish or maintain a session for an application.

16. The processor of claim 14, wherein the processor is further configured to:
perform an operation in response to identifying the change in network coverage without user intervention, wherein the operation comprises one of initiating a voice call, a data session or an emergency call.

17. The processor of claim 16, wherein the operation was previously attempted prior to the change in network coverage.

18. The processor of claim 14, wherein the user event comprises activating a display of the UE or unlocking the UE a predetermined number of times while deployed within the first type of network coverage.

19. The processor of claim 14, wherein the user event comprises receiving user input in response to a request for the user to enable the feature configured to alert the user to the change in network coverage, and
wherein the request is displayed at the UE in response to a predetermined condition.

20. The processor of claim 19, wherein the predetermined condition is based on one or more of a type of network coverage being unavailable, a duration of time the UE is deployed within the first type of network coverage, a number of times a display device of the UE is activated, a number of times the UE is unlocked, a failure to establish a communication session while deployed in the first type of network or a number of times the UE identifies the first type of network coverage within a time window.
